(19) United States
(12) Patent Application Publication
(10) Pub. No.: US 2025/0255425 A1
(43) Pub. Date: Aug. 14, 2025

(54) LOCKER APPARATUS

(71) Applicant: TOKAI RIKEN CO., LTD., Seki-shi (JP)

(72) Inventors: Akihiro SATO, Seki-shi (JP); Yoshiaki MUTO, Seki-shi (JP); Masami UMEMURA, Seki-shi (JP); Risa YONENUMA, Seki-shi (JP); Yasufumi ICHIHARA, Tokyo (JP)

(73) Assignee: TOKAI RIKEN CO., LTD., Seki-shi (JP)

(21) Appl. No.: 18/923,854

(22) Filed: Oct. 23, 2024

(30) Foreign Application Priority Data
Feb. 8, 2024 (JP) 2024-018012

(51) Int. Cl. A47G 29/14; A47G 29/30

(52) U.S. Cl. CPC A47G 29/141; A47G 29/30; A47G 2029/145

(57) ABSTRACT

In a locker apparatus, a control device locks a locking device in order to bring a door into a closed state except when luggage is deposited in a box and when the luggage is taken out from the box. An operation unit includes a take-out button that is operated in order to take out the luggage from the box in which the luggage has been deposited. When the take-out button is operated, the control device unlocks the locking device in order to open the door of the box in which the luggage has been deposited, and when the door is closed thereafter and it is determined that there is the luggage in the box based on a detection result of a luggage sensor, the control device maintains unlocking of the locking device.

### CROSS-REFERENCE TO RELATED APPLICATIONS

This application is based upon and claims the benefit of priority from the prior Japanese Patent Application No. 2024-018012, filed Feb. 8, 2024, the entire contents of which are incorporated herein by reference.

### BACKGROUND

### Technical Field

The technique disclosed in this specification relates to a locker apparatus that includes a box capable of accommodating luggage therein, a door for opening and closing the box, and a locking device for unlockably locking the door.

### Related Art

Conventionally, as this type of technique, for example, the techniques described in Japanese Utility Model Registration No. 3113126 (JP3113126U), Japanese Utility Model Registration No. 3113263 (JP3113263U), and Japanese Utility Model Registration No. 3220448 (JP3220448U) have been known. JP3113126U, JP3113263U, and JP3220448U each describe technique related to a normally closed-type coin locker that provisionally locks each door at all times when not in use.

Generally, conventional coin lockers are normally opened-type coin lockers in which each door is not locked when no luggage is deposited therein. Therefore, rubbish is sometimes thrown into boxes, or the boxes are sometimes used as luggage storage areas without permission, so that there are problems in terms of hygiene and crime prevention, and installation companies are forced to manage and handle these problems. In contrast, in each of the normally closed-type coin lockers described in JP3113126U, JP3113263U, and JP3220448U, each door is provisionally locked even when no luggage is deposited therein, which can reduce the burden of the above management and handling.

In recent years, as normally closed-type coin lockers, a type of locker apparatus in which a locking device is electrically activated and operated to be locked and unlocked without using a physical key, has become the mainstream. For example, a user checks an available box by a number at an operation unit provided in a locker apparatus, designates the number, and performs a payment operation for a usage fee. JP3113126U and JP3113263U each describe a payment method by cash, and JP3220448U describes a payment method by a credit card or the like. When the locker apparatus confirms payment of the usage fee in response to this payment operation, the locking device of the designated box is unlocked, the door opens, and it becomes possible to deposit luggage. When the user deposits luggage, closes the door, and confirms the operation, the locking device is locked. When the luggage is deposited as described above, a note on which the number of the designated box is recorded is issued to the user for convenience in taking out the luggage. For example, JP3113126U and JP3113263U each state that in depositing luggage, a receipt with a bar code is issued as a note from the locker apparatus, and in taking out the luggage, the user is authenticated by holding the issued receipt over a bar code reader, the locking device of the designated box is unlocked, and the door is opened. Meanwhile, JP3220448U states that by using a two-dimensional code such as a serial number code, a bar code, or a QR code (registered trademark) instead of a receipt, the user is authenticated and the locking device is unlocked.

### SUMMARY

### Technical Problems

In each of the normally closed-type locker apparatuses described in JP3113126U, JP3113263U, and JP3220448U, in order for the user to take out luggage from the box, the user unlocks the locking device of the designated box, opens the door, and then takes out the luggage. In such a case, for example, immediately after a user (A) takes out luggage from a box (X), a later user (B) may hurriedly place luggage into the box (X) by mistake before the door is closed. In this case, when the door is closed, the locking device is locked as a normal standby operation in the normally closed-type locker apparatus, and the door is locked. That is, in this state, since this locking is after the previous user (A) took out the luggage, the box (X) in which the later user (B) placed the luggage is regarded as an empty box, and the door is locked. Therefore, thereafter, another user (C) may select the box (X) as an available empty box, and if the locking device of the box (X) is unlocked, the door opens to allow the luggage in the box (X) to be taken out, which causes a security problem.

The disclosed technique has been made in view of the above circumstances, and an object of the disclosed technique is to provide a locker apparatus that can prevent a door from being locked even if a later user tries to deposit luggage by mistake in a box from which a previous user has taken out luggage.

### Means of Solving the Problems

(1) In order to achieve the above object, one aspect of the disclosed technique is directed to a locker apparatus including: a box capable of accommodating luggage therein; a door configured to open and close the box; a locking device configured to unlockably lock the door; an operation unit configured to receive an operation by a user; and a control device configured to control the locking device in response to an operation on the operation unit by the user, wherein the control device is configured to lock the locking device in order to lock the door into a closed state except when the luggage is deposited in the box and when the luggage is taken out from the box, the box is provided with a luggage sensor configured to detect luggage in the box, the operation unit includes a take-out button that is operated by the user in order to take out the luggage from the box in which the user has deposited the luggage, and when the take-out button is operated by the user, the control device unlocks the locking device in order to open the door of the box in which the luggage has been deposited, and when the door is closed thereafter and it is determined that there is the luggage in the box based on a detection result of the luggage sensor, the control device maintains unlocking of the locking device.

According to the above configuration (1), when the take-out button is operated by the user in order to take out luggage from the box in which the user has deposited the luggage, the locking device is unlocked in order to open the door of the box in which the luggage has been deposited. When the door is closed thereafter, the unlocking of the locking device is maintained when it is determined that there is luggage in the box based on the detection result of the luggage sensor. Therefore, when a user takes luggage from the box in which the user has deposited the luggage, even if a later user deposits luggage in the box by mistake and closes the door, the locking device is not locked.

(2) In order to achieve the above object, in the above configuration (1), preferably, a luggage lamp configured to operate in order to indicate whether or not there is the luggage in the box is further included, and the control device causes the luggage lamp to light up or flash while determining that there is the luggage in the box as a target based on the detection result of the luggage sensor after the take-out button is operated by the user.

According to the above configuration (2), in addition to the action of the above configuration (1), the luggage lamp lights up or blinks while it is determined that there is the luggage in the target box based on the detection result of the luggage sensor after the take-out button is operated by the user. Therefore, even if a later user deposits luggage in this box by mistake, the mistaken deposit is notified to the later user.

(3) In order to achieve the above object, in the above configuration (1) or (2), preferably, reservation acceptance member configured to accept a use reservation for the box is further included, the control device is configured to record and manage a current status of each box that is in use and each box that is not in use, and to manage acceptance and recording of a use reservation from the reservation acceptance member for each box that is not in use, and the control device stops accepting a use reservation from the reservation acceptance member for the box in which it is determined that there is the luggage based on the detection result of the luggage sensor.

According to the above configuration (3), in addition to the action of the above configuration (1) or (2), the control device manages the use status of each box, and also manages acceptance and recording of a use reservation for each box that is not in use. Here, when a user takes out luggage from a box in which the user has deposited the luggage, this box appears to be empty once. However, the control device stops accepting a use reservation for each box in which it is determined that there is luggage based on the detection result of the luggage sensor. Therefore, when a user takes out luggage from a box, even if a later user deposits luggage in this box by mistake and another user tries to make a use reservation for this box at the same time, the reservation is not accepted.

According to the above configuration (1), even if a later user deposits luggage by mistake in the box from which a previous user took out luggage, the door can be prevented from being locked.

According to the above configuration (2), in addition to the effect of the above configuration (1), a later user can recognize mistaken deposit of luggage early and take action therefor.

According to the above configuration (3), in addition to the effect of the above configuration (1) or (2), even if a later user deposits luggage by mistake in the box from which a previous user took out luggage, still another user can be prevented from making a use reservation for this box.

### BRIEF DESCRIPTION OF THE DRAWINGS

FIG. 1 is a front view showing a locker apparatus according to a first embodiment;

FIG. 2 is a block diagram showing the electrical configuration of the locker apparatus according to the first embodiment;

FIG. 3 shows a standby screen displayed on a display unit when a luggage take-out mode is executed according to the first embodiment;

FIG. 4 shows an authentication selection screen displayed on the display unit when the luggage take-out mode is executed according to the first embodiment;

FIG. 5 shows an authentication execution screen displayed on the display unit when the luggage take-out mode is executed according to the first embodiment;

FIG. 6 shows an authentication execution screen displayed on the display unit when the luggage take-out mode is executed according to the first embodiment;

FIG. 7 shows an authentication execution screen displayed on the display unit when the luggage take-out mode is executed according to the first embodiment;

FIG. 8 shows a box selection screen displayed on the display unit when the luggage take-out mode is executed according to the first embodiment;

FIG. 9 shows a take-out confirmation screen displayed on the display unit when the luggage take-out mode is executed according to the first embodiment;

FIG. 10 shows a redeposit confirmation screen displayed on the display unit when the luggage take-out mode is executed according to the first embodiment;

FIG. 11 shows a box unlocking screen displayed on the display unit when the luggage take-out mode is executed according to the first embodiment;

FIG. 12 shows an end screen displayed on the display unit when the luggage take-out mode is executed according to the first embodiment;

FIG. 13 shows a first warning screen displayed on the display unit when the luggage take-out mode is executed according to the first embodiment;

FIG. 14 shows a second warning screen displayed on the display unit when the luggage take-out mode is executed according to the first embodiment;

FIG. 15 shows a box unlocking screen displayed on the display unit when the luggage take-out mode is executed according to the first embodiment;

FIG. 16 shows an end screen displayed on the display unit when the luggage take-out mode is executed according to the first embodiment; and

FIG. 17 shows a warning screen displayed on a display unit when a luggage take-out mode is executed according to a second embodiment.

### DETAILED DESCRIPTION OF THE EXEMPLARY EMBODIMENTS

Hereinafter, embodiments in which the locker apparatus of the disclosed technique is embodied will be described in detail with reference to the drawings.

### First Embodiment

First, a first embodiment will be described.

### (Outline of Configuration of Locker Apparatus)

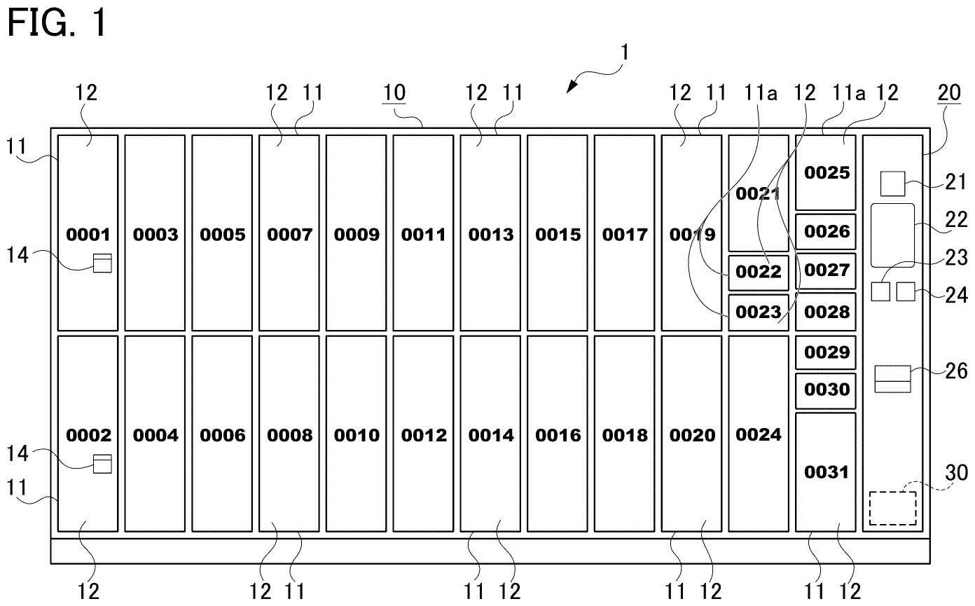

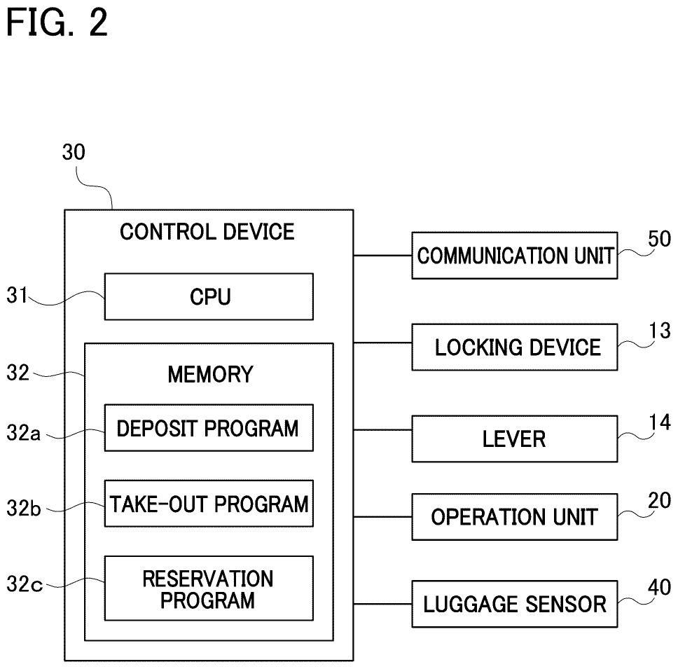

FIG. 1 shows a locker apparatus 1 in a front view. FIG. 2 shows the electrical configuration of the locker apparatus 1 in a block diagram. The locker apparatus 1 of this embodiment is installed on the premises of a railroad station and used to temporarily deposit and keep luggage, for example.

As shown in FIG. 1, the locker apparatus 1 includes a housing 10, a plurality of boxes 11 that are capable of accommodating luggage in the housing 10, an operation unit 20 for receiving an operation by a user in order for the user to place or take out luggage in or from a box 11, and a control device 30 that controls opening/closing, locking/unlocking, etc., of each box 11 and display, etc., of the operation unit 20 in response to operations on the operation unit 20 by the user.

### (Configuration of Boxes)

As shown in FIG. 1, the locker apparatus 1 includes the plurality of boxes 11 each capable of accommodating luggage of the user therein. Specifically, as shown in FIG. 1, the locker apparatus 1 schematically includes a total of 24 boxes 11 in 2 rows×12 columns, and the two rightmost columns on the upper row and the rightmost one column on the lower row in FIG. 1 include a plurality of small boxes 11a each having a small frontage. The numbers of boxes 11 and small boxes 11a of this embodiment are merely an example, and can be increased or decreased as necessary. In addition, the locker apparatus 1 of this embodiment includes the plurality of boxes 11 and small boxes 11a having different frontages as shown in FIG. 1, but all of the plurality of boxes can also be configured with the same frontage.

At the front opening of each box 11 or 11a, a door 12 that can be opened and closed independently for each box 11 or 11a is provided. A box number (0001 to 0031) is attached to the surface of each door 12 to specify the corresponding box 11 or 11a. In this embodiment, each door 12 is, for example, a left-opening door that opens to the left of the box 11 or 11a in the drawing, but may also be a right-opening door that opens to the right of the box 11 or 11a in the drawing. A locking device 13 (see FIG. 2) described later is provided inside each box 11 or 11a. In this embodiment, the description of the specific configuration of the locking device 13 is omitted. In addition, each box 11 or 11a is provided with a luggage sensor 40 (see FIG. 2) for detecting luggage in this box 11 or 11a. As the luggage sensor 40, for example, a contact type sensor that detects the presence or absence of luggage by detecting the weight of the luggage, or a non-contact type sensor that detects the presence or absence of luggage by detecting the reflection of light waves or the like on the luggage, can be used.

The door 12 of each box 11 or 11a is provided with a lever 14 that is operated by the user in order to request the locking device 13 to lock when the user has deposited luggage in the box 11 or 11a and has closed the door 12. In FIG. 1, for convenience, the levers 14 are shown only on the doors 12 with door numbers of “0001” and “0002”, but omitted their illustration on the other doors 12.

### (Configuration of Operation Unit)

As shown in FIG. 1, the operation unit 20 includes a camera 21 for recognizing users, a display unit 22 with a liquid crystal screen for exchanging information with users, a QR code reader 23 for reading data such as QR codes (registered trademark) from users, a settlement terminal 24 that can read IC tags incorporated into cash cards, and a printer 26 for printing a receipt or the like for proof of use. Data input from users can be performed using the QR code reader 23 and the settlement terminal 24. Here, a cash card is, for example, a card that allows settlement of electronic money, such as a transportation IC card. The display unit 22, the QR code reader 23, and the settlement terminal 24 of the operation unit 20 correspond to “authentication member” for authenticating the user. The display unit 22 is configured to display at least one of a virtual button, an illustration of a locker apparatus, and a text, as described later.

### (Configuration of Control Device)

The control device 30 is provided inside the operation unit 20, and is configured to control the locking device 13 of each box 11 or 11a in response to an operation on the operation unit 20 by the user. As shown in FIG. 2, the control device 30 includes a CPU 31 and a memory 32. For example, a deposit program 32a for performing control when luggage is to be deposited in a box 11 or 11a and a take-out program 32b for performing control when luggage is to be taken out from a box 11 or 11a are stored in the memory 32. The control device 30 is electrically connected to each locking device 13, each lever 14, and the operation unit 20, and is configured to perform control of each locking device 13, screen display of the display unit 22, etc., based on the deposit program 32a or the take-out program 32b. In FIG. 2, only one locking device 13 is shown for convenience, but in actuality, locking devices 13 whose number is equal to the number of boxes 11 and 11a are connected to the control device 30. In addition, a communication unit 50 is connected to the control device 30, and the locker apparatus 1 is capable of communicating with a management apparatus (not shown) via the communication unit 50. The management apparatus is an apparatus that is installed on the premises of a station or any other predetermined location and is higher in rank than the locker apparatus 1. In this embodiment, the communication unit 50 corresponds to an example of “reservation acceptance member” for accepting use reservations for the boxes 11 and 11a. The control device 30 is configured to record and manage the current statuses of the boxes 11 and 11a that are in use and the boxes 11 and 11a that are not in use, and to manage acceptance and recording of use reservations from the communication unit 50 for the boxes 11 and 11a that are not in use, and a reservation program 32c therefor is provided in the memory 32. Furthermore, each luggage sensor 40 is connected to the control device 30. The control device 30 is configured to determine whether or not there is luggage in each box 11 or 11a, based on a detection result from the luggage sensor 40. In FIG. 2, only one luggage sensor 40 is shown for convenience, but in actuality, luggage sensors 40 whose number is equal to the number of boxes 11 and 11a are connected to the control device 30. Furthermore, the control device 30 is configured to stop accepting a use reservation from the communication unit 50 (reservation acceptance member) for each box 11 or 11a in which it is determined that there is luggage based on the detection result of the luggage sensor 40.

The control device 30 is configured to automatically open and close the door 12 of each box 11 or 11a by controlling the locking device 13. In addition, each locking device 13 of this embodiment normally locks each door 12 into a closed state. When each door 12 is to be opened, the door 12 is opened manually, and when each door 12 is to be closed, the door 12 is closed manually or automatically by a spring or the like.

The locker apparatus 1 of this embodiment is a so-called “normally closed-type locker apparatus”, and the control device 30 is configured to lock each locking device 13 in order to lock the door 12 into a closed state except when the user deposits luggage in the box 11 or 11a and when the user takes out luggage from the box 11 or 11a.

### (Luggage Deposit Procedure)

Next, the procedure for the user to deposit luggage in the locker apparatus 1 will be described.

A state where no luggage is accommodated (state where the user can deposit luggage) in the plurality of boxes 11 and 11a is referred to as “standby mode”. Each box 11 or 11a in the standby mode is in a locked state. At this time, the locking device 13 locks the door 12 of the box 11 or 11a into a closed state.

In the standby mode, in order to deposit luggage in the box 11 or 11a, the user first performs acceptance of the start of use by using the operation unit 20. The control device 30 displays a virtual button for selecting deposit, on the display unit 22, and starts the acceptance by the user tapping the virtual button. At this time, the control device 30 can notify the user of each available empty box 11 or 11a by displaying a door number thereof based on the detection result of the luggage sensor 40. Here, the virtual button is an illustration displayed on the display unit 22, and is a button that functions electrically when the user taps the button on the screen.

Then, the control device 30 displays a usage fee on the display unit 22. The user who has confirmed the fee enters use data and settles the fee using the QR code reader 23 and the settlement terminal 24. In the settlement, for example, the unique number of the IC tag of an IC card read by the settlement terminal 24 is stored in the memory 32, and this data is used for authentication when luggage is to be taken out. After the settlement is performed, the control device 30 prints a receipt as a certificate of use using the printer 26. The settlement is not limited to the form using an IC card, and may be another form such as credit card settlement or QR code settlement, or a plurality of forms may be selectively combined. In addition, when settlement is performed by a method other than an IC card, a private code such as a QR code (registered trademark) for unlocking can be printed on a receipt, and authentication can be performed by reading the printed private code.

### (Luggage Take-Out Procedure)

Next, the procedure for the user to take out luggage from the locker apparatus 1 will be described.

In order to take out luggage from the locker apparatus 1, the user enters necessary data into the operation unit 20. The control device 30 displays a virtual button for selecting take-out on the display unit 22, and starts the acceptance by the user tapping the virtual button. At this time, if the daily usage fee for the locker apparatus 1 is exceeded, for example, if the locker apparatus 1 has been used over two days, the excess fee is deducted by credit card settlement, cashless settlement, or the like to complete payment. After the payment is completed, the control device 30 unlocks the locking device 13 to open the door 12 of the box 11 or 11a. The user takes out the luggage from the box 11 or 11a and closes the door 12. At this time, the control device 30 locks the locking device 13 to lock the door 12 of the box 11 or 11a into a closed state.

(Technical Features of Locker Apparatus of this Embodiment)

In order to solve the problems of the conventional normally closed-type locker apparatuses described above, the normally closed-type locker apparatus 1 of this embodiment is configured to be able to execute a “luggage take-out mode” for, immediately after a previous user takes out luggage from a box 11 or 11a, preventing a door 12 from being locked even if a later user tries to deposit luggage by mistake in this box 11 or 11a.

### (Operation of Luggage Take-Out Mode)

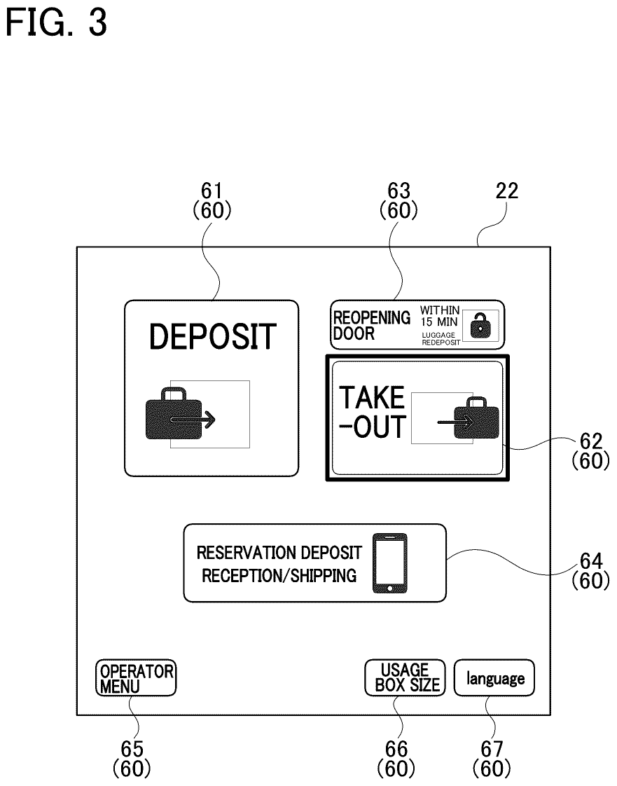

In this embodiment, the control device 30 is configured to sequentially transition the screen of the display unit 22 from a predetermined “standby screen” in response to an operation on a virtual button by the user. FIG. 3 to FIG. 16 each show a transition screen displayed on the display unit 22 when the “luggage take-out mode” is executed. The control device 30 controls interactive screen transitions on the display unit 22 related to the “luggage take-out mode” based on the preset take-out program 32b.

First, when the user faces the display unit 22 of the operation unit 20, the control device 30 displays a “standby screen” shown in FIG. 3 on the display unit 22. A plurality of virtual buttons 60 that can be tapped are displayed on the standby screen. A deposit button 61 that is operated by the user when the user deposits luggage in a box 11 or 11a, a take-out button 62 that is operated by the user in order to take out luggage from a box 11 or 11a in which the user has deposited the luggage, and a reopening door button 63 that can be operated by the user to give an instruction to reopen a door 12 are displayed in the upper part of the standby screen. The reopening door button 63 is a button that is operated by the user particularly when the user redeposits luggage in a box 11 or 11a, not for taking out luggage from a box 11 or 11a. In this embodiment, redeposit of luggage through an operation on the reopening door button 63 can be performed within a “15-minute time limit”. On the standby screen, the deposit button 61 and the take-out button 62 are displayed side by side, and the reopening door button 63 is placed adjacent to the upper side of the take-out button 62. The width of the reopening door button 63 is substantially equal to that of the take-out button 62, and the height of the reopening door button 63 is smaller than that of the take-out button 62. By this size setting, the take-out button 62 for take-out of luggage which occurs more frequently than redeposit of luggage is made more conspicuous than the reopening door button 63 to eliminate mistakes in button operation. In addition, a reservation deposit button 64 for instructing reservation deposit, reception, and shipping of luggage is displayed in the middle part of the standby screen. Furthermore, an operator menu button 65 for selecting a luggage handling business operator, a usage button 66 for instructing explanation of the usage and designating a box size, and a language button 67 for selecting a display language are displayed in the lower part of the standby screen.

On the standby screen, the user taps the reopening door button 63 when executing the “reopening door mode”. In this embodiment, a door 12 can be opened again without any fee within a predetermined time immediately after luggage is deposited. In this embodiment, “within 15 minutes” is set as within the predetermined time. In addition, in this embodiment, each door 12 is set such that the door 12 can be opened multiple times “within 15 minutes”.

On the standby screen, the user taps the take-out button 62 in order to execute the “luggage take-out mode” and take out luggage.

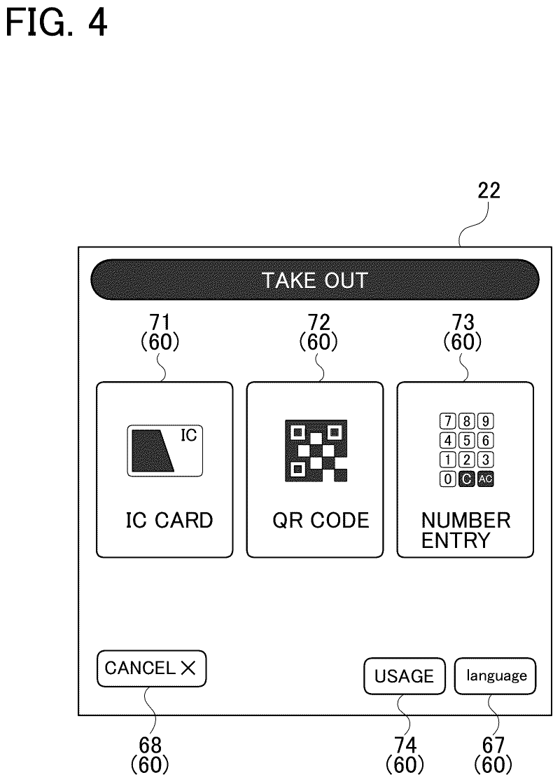

If the take-out button 62 is tapped, the control device 30 causes the display of the display unit 22 to transition to an “authentication selection screen” shown in FIG. 4. On the authentication selection screen, a text or the like, and a plurality of virtual buttons 60 that can be tapped are displayed in order to select an authentication method. A text “Take out” is displayed in the upper part of the authentication selection screen. In addition, a plurality of types of authentication buttons for selecting one of a plurality of authentication methods are displayed in the middle part of the authentication selection screen. That is, as the authentication buttons, an IC card button 71 for selecting the use of an IC card, a QR code button 72 for selecting the use of a QR code (registered trademark), and a number entry button 73 for selecting number entry are displayed in the middle part of the authentication selection screen. In addition, a cancellation button 68 for cancelling an operation, a usage button 74 for instructing explanation of the usage, and a language button 67 are displayed in the lower part of the authentication selection screen.

A payment method in depositing luggage differs depending on the user, and thus the user taps a suitable one from among the various buttons 71 to 73.

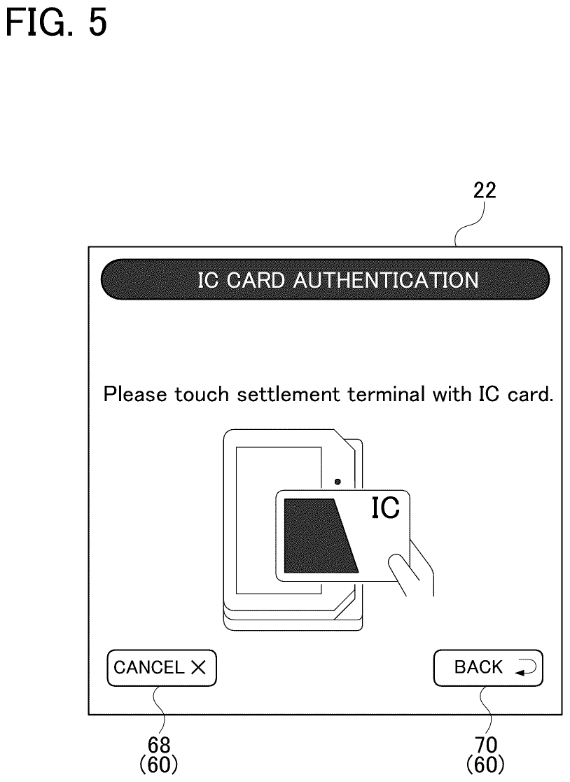

Here, if the IC card button 71 is tapped, the control device 30 causes the display of the display unit 22 to transition from the authentication selection screen to an “authentication execution screen” shown in FIG. 5. On the authentication execution screen, a text or the like, an illustration, and virtual buttons 60 that can be tapped are displayed. A text “IC card authentication” is displayed in the upper part of the authentication execution screen. In addition, an illustration prompting an operation on the authentication member corresponding to a selected one authentication method, and an explanation text therefor are displayed in the middle part of the authentication execution screen. That is, an explanation text “Please touch settlement terminal with IC card”, and an illustration representing this are displayed in the middle part of the authentication execution screen. In addition, a cancellation button 68 and a back button 70 are displayed in the lower part of the authentication execution screen.

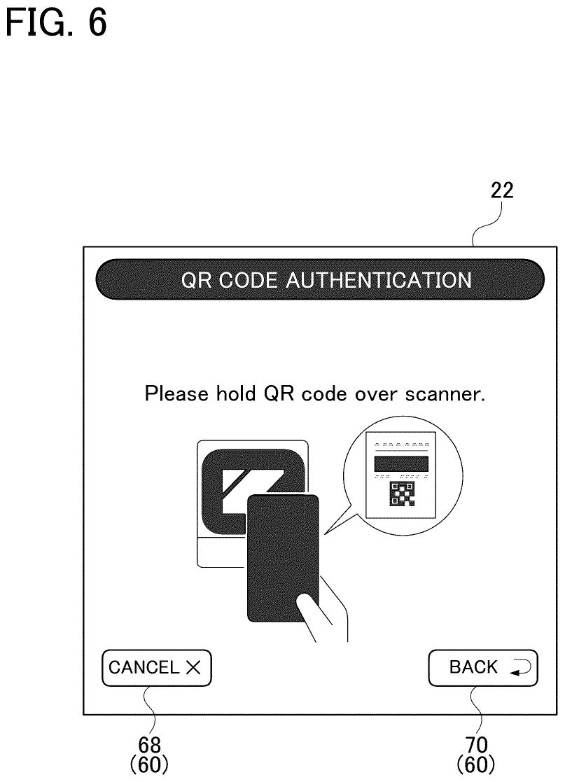

Meanwhile, if the QR code button 72 is tapped, the control device 30 causes the display of the display unit 22 to transition to an “authentication execution screen” shown in FIG. 6. On the authentication execution screen, a text or the like, an illustration, and virtual buttons 60 that can be tapped are displayed. A text “QR code authentication” is displayed in the upper part of the authentication execution screen. In addition, an explanation text “Please hold QR code over scanner”, and an illustration representing this are displayed in the middle part of the authentication execution screen. In addition, a cancellation button 68 and a back button 70 are displayed in the lower part of the authentication execution screen.

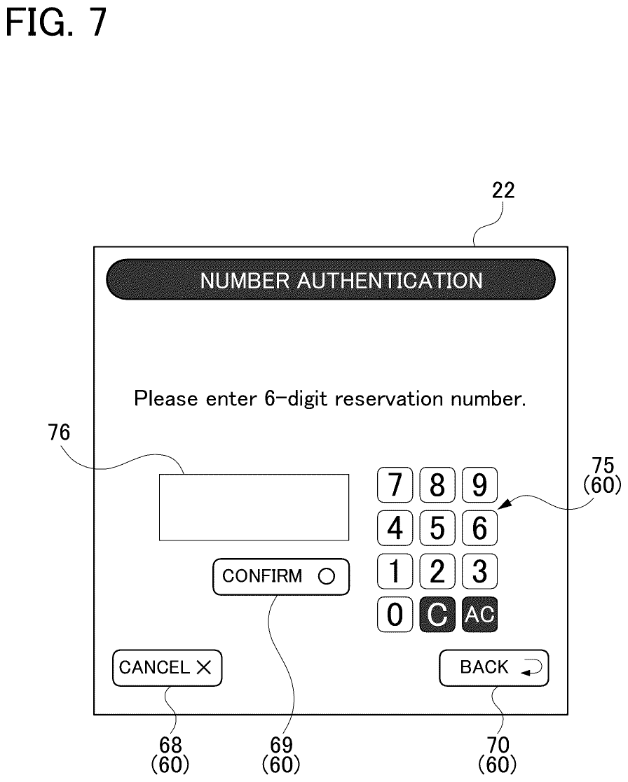

If the number entry button 73 is tapped, the control device 30 causes the display of the display unit 22 to transition to an “authentication execution screen” shown in FIG. 7. On the authentication execution screen, a text or the like, an illustration, and virtual buttons 60 that can be tapped are displayed. A text “Number authentication” is displayed in the upper part of the authentication execution screen. In addition, an explanation text “Please enter 6-digit reservation number”, a ten-key button 75 as authentication member for entering a number, a small display 76 for displaying the entered number, and a confirmation button 69 are displayed in the middle part of the authentication execution screen. In addition, a cancellation button 68 and a back button 70 are displayed in the lower part of the authentication execution screen.

The user performs authentication in accordance with the authentication method corresponding to one selected screen out of the three authentication execution screens described above.

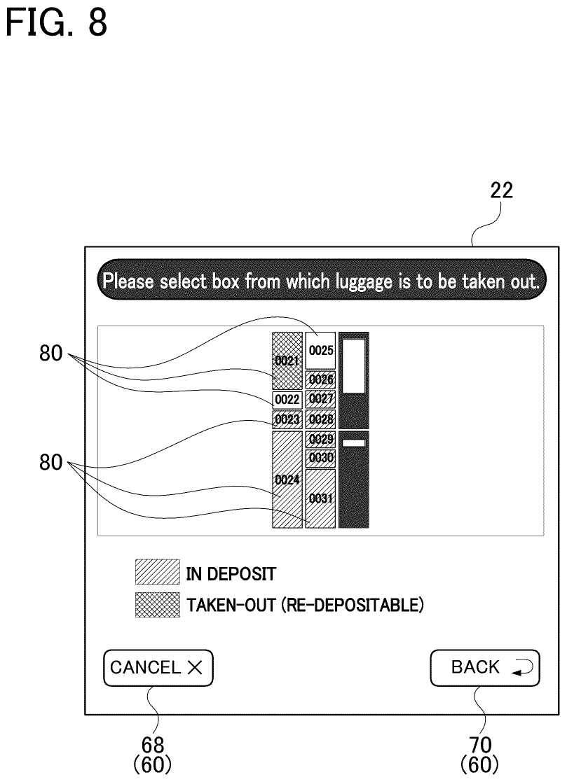

Here, it is assumed that the user performs “IC card authentication” in accordance with the authentication execution screen shown in FIG. 5, for example. In this case, the control device 30 causes the display of the display unit 22 to transition from the authentication execution screen to a “box selection screen” shown in FIG. 8. On the box selection screen, a text or the like, an illustration, and virtual buttons 60 that can be tapped are displayed. An explanation text “Please select box from which luggage is to be taken out” is displayed in the upper part of the box selection screen. An illustration of a locker apparatus and an explanation of the coloring in the illustration are displayed in the middle part of the box selection screen. In the illustration of the locker apparatus, the numbers corresponding to the boxes 11 and 11a in each of which the user has deposited luggage, and selection buttons 80 that can be selected to select these numbers are displayed. In this illustration, boxes with numbers corresponding to the respective boxes 11 and 11a are the selection buttons 80. In addition, a cancellation button 68 and a back button 70 are displayed in the lower part of the box selection screen.

If the user performs authentication with an IC card, there may be a plurality of target boxes. In this case, the target boxes are displayed in color (e.g., green or yellow) in the illustration of the locker apparatus on the box selection screen shown in FIG. 8. For example, in FIG. 8, if there are a plurality of target boxes, the corresponding boxes are displayed in color in the illustration of the locker apparatus (shown with diagonal lines or a grid in FIG. 8). The user selects a box to be unlocked from among the colored boxes by tapping. If there is only one target box, the control device 30 skips the display of the box selection screen in FIG. 8.

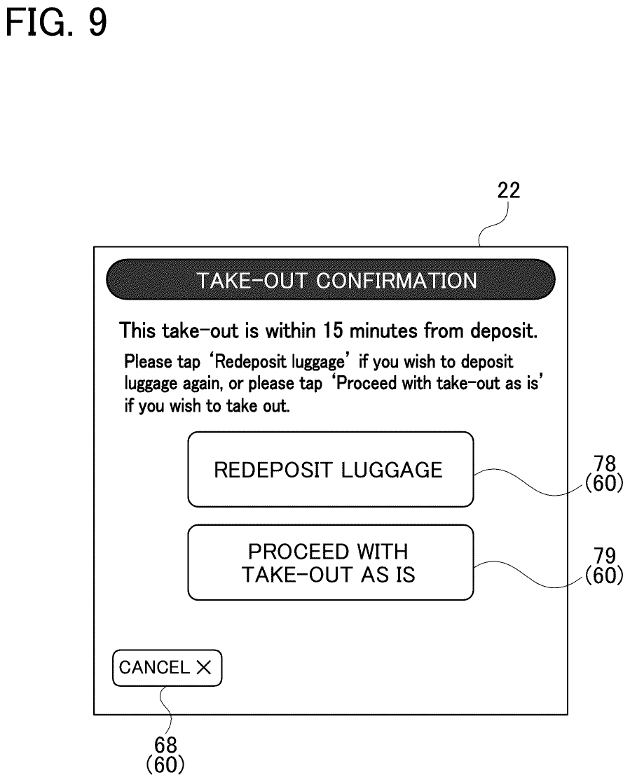

If the user taps a box to be unlocked from among the colored boxes on the box selection screen in FIG. 8 and this tap is “within 15 minutes” from deposit of luggage, the control device 30 causes the display of the display unit 22 to transition to a “take-out confirmation screen” shown in FIG. 9. On the take-out confirmation screen, a text or the like, and a plurality of virtual buttons 60 that can be tapped are displayed. A text “Take-out confirmation” and an explanation text “This take-out is within 15 minutes from deposit. Please tap ‘Redeposit luggage’ if you wish to deposit luggage again, or please tap ‘Proceed with take-out as is’ if you wish to take out” are displayed in the upper part of the take-out confirmation screen. In addition, a luggage redeposit button 78 for instructing redeposit of luggage and a take-out button 79 for instructing take-out of luggage as is are displayed in the middle part of the take-out confirmation screen. Furthermore, a cancellation button 68 is displayed in the lower part of the take-out confirmation screen. In this embodiment, this take-out confirmation screen is provided on the assumption that the user may intend to redeposit luggage but tap the take-out button 62 by mistake instead of the reopening door button 63.

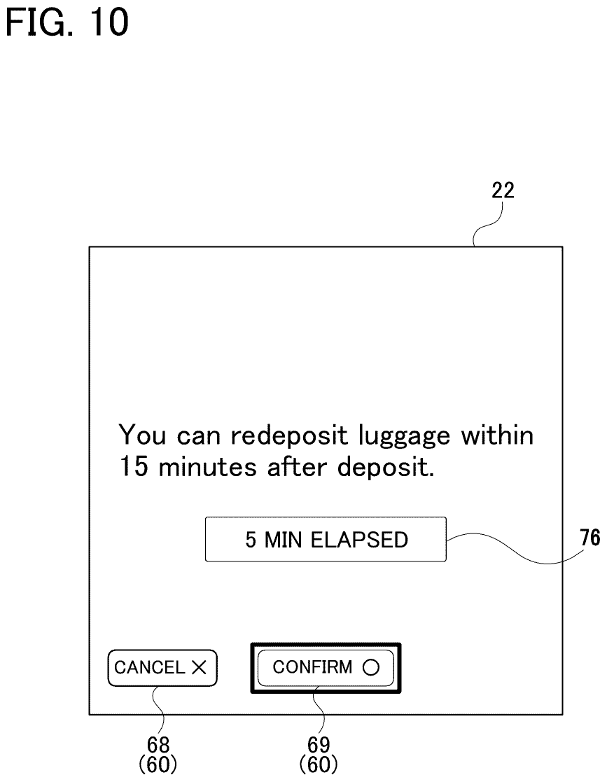

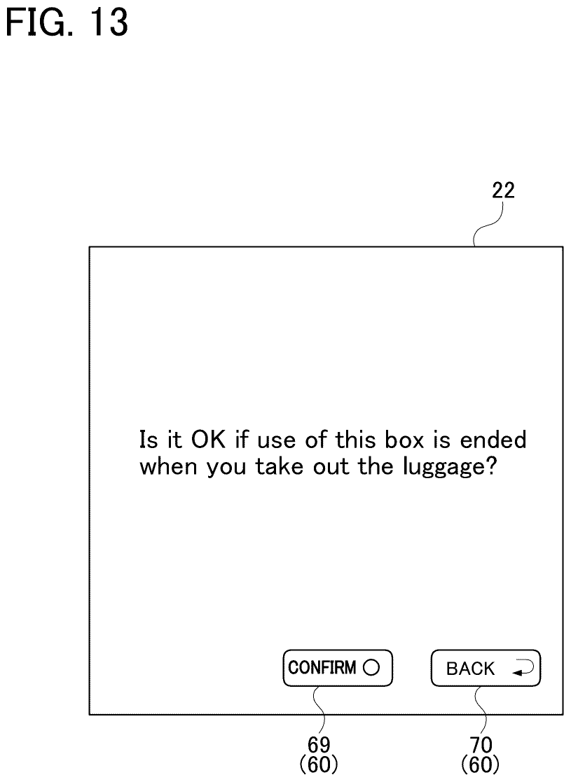

If the user selectively taps either one of the buttons 78 and 79 on the take-out confirmation screen, the control device 30 causes the display of the display unit 22 to transition to a “redeposit confirmation screen” shown in FIG. 10 or a “first warning screen” shown in FIG. 13. However, even if take-out of luggage is “within 15 minutes”, if the luggage is to be taken out again, the redeposit confirmation screen and the box unlocking screen are not displayed.

If the user taps the luggage redeposit button 78 on the take-out confirmation screen, the control device 30 causes the display of the display unit 22 to transition to the “redeposit confirmation screen” shown in FIG. 10. On the redeposit confirmation screen, a text or the like, and a plurality of virtual buttons 60 that can be tapped are displayed. An explanation text “You can redeposit luggage within 15 minutes after deposit”, and a small display 76 indicating the elapsed time from the deposit are displayed in the middle part of the redeposit confirmation screen. In addition, a cancellation button 68 and a confirmation button 69 are displayed in the lower part of the redeposit confirmation screen.

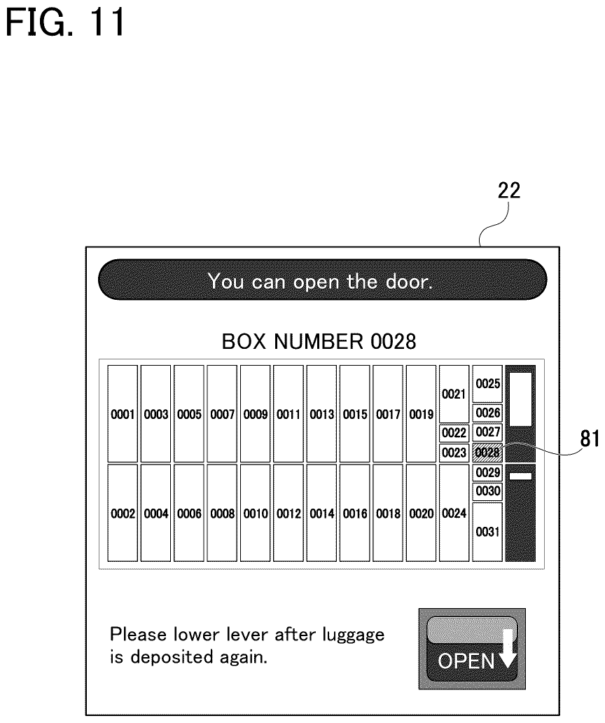

If the user taps the confirmation button 69, the control device 30 causes the display of the display unit 22 to transition to a “box unlocking screen” shown in FIG. 11. On the box unlocking screen, a text or the like, an illustration, and virtual buttons 60 that can be tapped are displayed. An explanation text “You can open the door” is displayed in the upper part of the box unlocking screen, and a text “Box number 0028” indicating a target box, and an illustration of a locker apparatus are displayed in the middle part of the same screen. In this case, the target box 81 with “0028” is colored (e.g., in green) and blinked in the illustration of the locker apparatus (shown with diagonal lines in FIG. 11). In addition, an explanation text prompting an operation on the lever 14 after luggage is deposited again, and an illustration for the operation on the lever 14 are displayed in the lower part of the box unlocking screen. That is, an explanation text “Please lower lever after luggage is deposited again”, and an illustration for the operation on the lever 14 are displayed in the lower part of the box unlocking screen.

When this box unlocking screen is displayed, the control device 30 unlocks the locking device 13 of the target box 11 or 11a in the actual locker apparatus 1. The user opens the door 12 of this box 11 or 11a, takes out luggage from the box 11 or 11a, then closes the door 12, and lowers the lever 14 to the closed side.

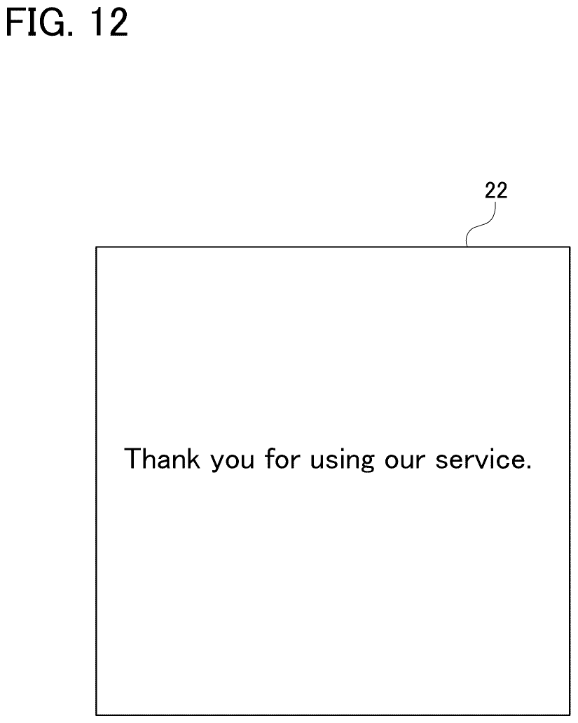

When the lever 14 is lowered to the closed side, the control device 30 causes the display of the display unit 22 to transition to an “end screen” shown in FIG. 12. An explanation text “Thank you for using our service” is displayed in the middle part of the end screen. Then, the control device 30 returns the display of the display unit 22 to the standby screen shown in FIG. 3.

Meanwhile, if the user taps the take-out button 79 on the take-out confirmation screen shown in FIG. 9, the control device 30 causes the display of the display unit 22 to transition to the “first warning screen” shown in FIG. 13. On the first warning screen, a text or the like, and virtual buttons 60 that can be tapped are displayed. An explanation text “Is it OK if use of this box is ended when you take out the luggage?” is displayed in the middle part of the first warning screen. In addition, a confirmation button 69 and a back button 70 are displayed in the lower part of the first warning screen.

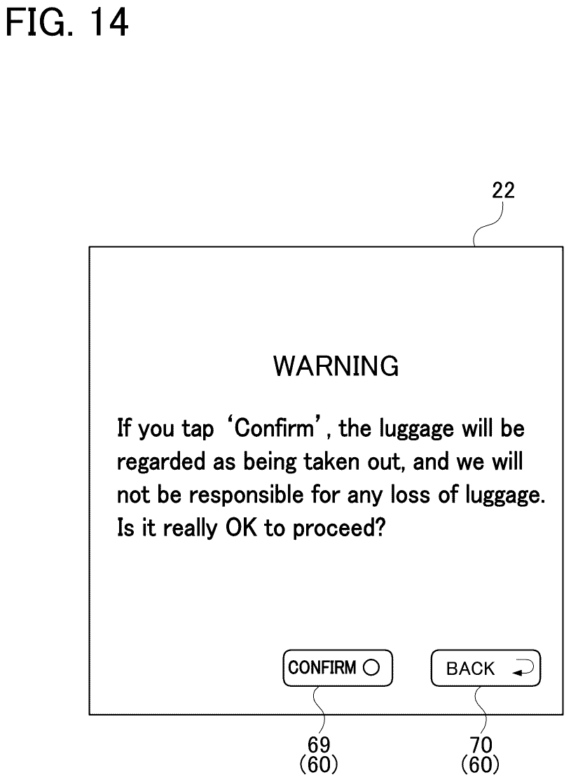

If the user taps the confirmation button 69 on the first warning screen, the control device 30 causes the display of the display unit 22 to transition to a “second warning screen” shown in FIG. 14. On the second warning screen, a text or the like, and virtual buttons 60 that can be tapped are displayed. An explanation text “Warning: If you tap ‘Confirm’, the luggage will be regarded as being taken out, and we will not be responsible for any loss of luggage. Is it really OK to proceed?” is displayed in the middle part of the second warning screen. In addition, a confirmation button 69 and a back button 70 are displayed in the lower part of the second warning screen.

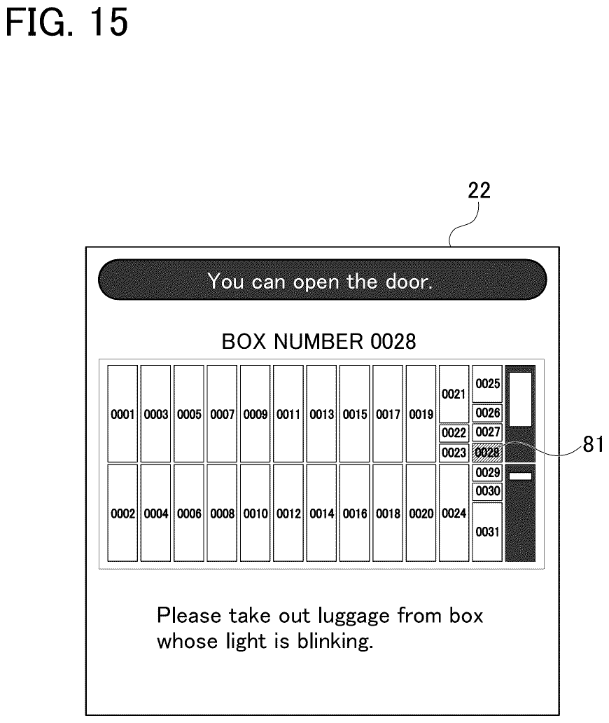

If the user taps the confirmation button 69 on the second warning screen shown in FIG. 14, the control device 30 displays a “box unlocking screen” shown in FIG. 15 on the display unit 22. On the box unlocking screen, a text or the like, and an illustration that can be tapped are displayed. An explanation text “You can open the door” is displayed in the upper part of the box unlocking screen. A text “Box number 0028” indicating a target box 81, and an illustration of a locker apparatus are displayed in the middle part of the box unlocking screen. In this case, the target box 81 with “0028” is colored (e.g., in green) and blinked in the illustration of the locker apparatus on the box unlocking screen (shown with diagonal lines in FIG. 15). In addition, an explanation text “Please take out luggage from box whose light is blinking” is displayed in the lower part of the box unlocking screen.

The box 81 blinking in the illustration of the locker apparatus displayed on the box unlocking screen shown in FIG. 15 corresponds to an example of a “luggage lamp” of the disclosed technique that operates to indicate whether or not there is luggage in the actual box 11 or 11a. When this box unlocking screen is displayed, the control device 30 unlocks the locking device 13 in order to open the door 12 of the box 11 or 11a in which luggage has been deposited, when the take-out button 62 is operated by the user, and the control device 30 maintains the unlocking of the locking device 13 when the door 12 is closed thereafter and it is determined that there is luggage in the box 11 or 11a based on the detection result of the luggage sensor 40. In addition, the control device 30 causes the corresponding box 81 (luggage lamp) in the illustration of the locker apparatus to flash while determining that there is luggage in the target box 11 or 11a based on the detection result of the luggage sensor 40 after the take-out button 62 is operated by the user. On the other hand, the control device 30 performs control in which, if it is determined that there is no luggage in the box 11 or 11a based on the detection result of the luggage sensor 40, the corresponding box 81 in the illustration of the locker apparatus is not caused to flash, and the locking device 13 is locked when the door 12 of the corresponding box 11 is closed.

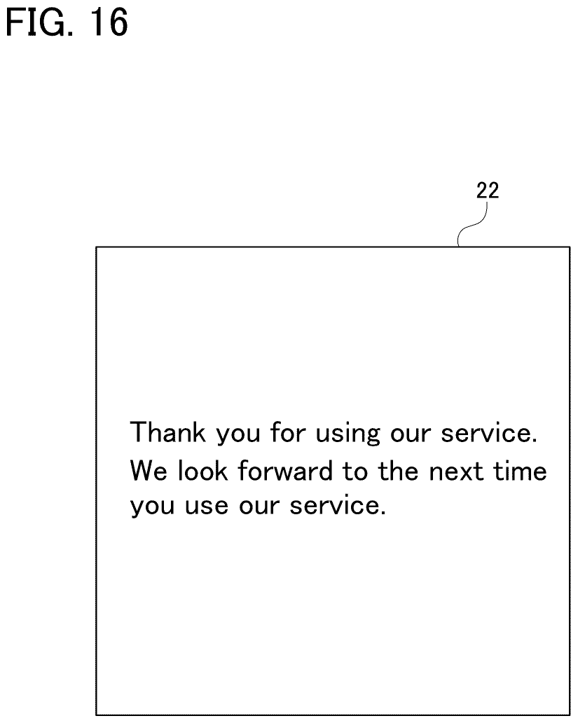

After the door 12 of the box 11 from which the user has taken out the luggage is locked, the control device 30 causes the display of the display unit 22 to transition to an “end screen” shown in FIG. 16. An explanation text “Thank you for using our service. We look forward to the next time you use our service.” is displayed in the middle part of the end screen. Then, the control device 30 returns the display of the display unit 22 to the standby screen shown in FIG. 3.

### (Action and Effects of Locker Apparatus)

With the configuration of the locker apparatus 1 of this embodiment described above, in the operation of the above “luggage take-out mode”, when the take-out button 62 on the standby screen shown in FIG. 3 is operated by the user, the control device 30 unlocks the locking device 13 in order to open the door 12 of the box 11 or 11a in which luggage has been deposited, and when the door 12 is closed thereafter and it is determined that there is luggage in the box 11 or 11a based on the detection result of the luggage sensor 40, the control device 30 maintains the unlocking of the locking device 13.

Therefore, when a user takes out luggage from the box 11 or 11a in which the user has deposited the luggage, even if a later user deposits luggage in the box 11 or 11a by mistake and closes the door 12, the locking device 13 is not locked. Thus, even if a later user tries to deposit luggage by mistake in the box 11 or 11a from which a previous user took out luggage, the door 12 can be prevented from being locked. As a result, the later user can be prevented from depositing luggage in the box 11 or 11a by mistake, so that security problems regarding deposited luggage can be avoided.

In the above case, the later user who has tried to deposit the luggage by mistake performs an operation for depositing the luggage in accordance with the transition screen of the display unit 22 at the operation unit 20. However, since there is already luggage in the box 11 or 11a that this user is trying to use, the control device 30 cannot recognize this box 11 or 11a as an empty box based on the detection result of the luggage sensor 40, and does not permit the user to deposit the luggage in this box 11 or 11a. In response to this, the later user selects a different empty box 11 or 11a and deposits the luggage therein again.

With the configuration of this embodiment, in the operation of the above “luggage take-out mode”, the control device 30 is configured to display the box 81 in the illustration of the locker device on the box unlocking screen shown in FIG. 15 so as to flash while determining that there is luggage in the target box 11 or 11a based on the detection result of the luggage sensor 40 after the take-out button 62 is operated by the user.

Therefore, even if a later user deposits luggage in this box 11 or 11a by mistake, the mistaken deposit is notified to the later user. Thus, the later user can recognize the mistaken deposit of the luggage early and take action therefor.

With the configuration of this embodiment, in the operation of the above “luggage take-out mode”, the control device 30 records and manages the current statuses of the boxes 11 and 11a that are in use and the boxes 11 and 11a that are not in use, and also manages acceptance and recording of use reservations from the communication unit 50 for the boxes 11 and 11a that are not in use. In addition, the control device 30 is configured to stop accepting a use reservation from the communication unit 50 for each box 11 or 11a in which it is determined that there is luggage based on the detection result of the luggage sensor 40.

With the above configuration, the control device 30 manages the use statuses of the boxes 11 and 11a and also manages acceptance and recording of use reservations for the boxes 11 and 11a that are not in use. Here, when a user takes out luggage from a box 11 or 11a in which the user has deposited the luggage, this box 11 or 11a appears to be empty once. However, the control device 30 stops accepting a use reservation for each box 11 or 11a in which it is determined that there is luggage based on the detection result of the luggage sensor 40. Therefore, when a user takes out luggage from a box 11 or 11a, even if a later user deposits luggage in this box 11 or 11a by mistake and another user tries to make a use reservation for this box 11 or 11a at the same time, the reservation is not accepted. Thus, even if the later user deposits the luggage by mistake in the box 11 or 11a from which the previous user took out the luggage, still another user can be prevented from making a use reservation for this box 11 or 11a. As a result, even if the later user leaves the luggage in the box 11 or 11a as it is, a situation in which another user who has made a reservation opens the door 12 of this box 11 or 11a can be avoided, so that security problems regarding left luggage can be avoided.

With the configuration of this embodiment, as for the transition screens when the “luggage take-out mode” is executed, the “first warning screen” shown in FIG. 13 and the “second warning screen” shown in FIG. 14 are provided between the end screen shown in FIG. 12 and the box unlocking screen shown in FIG. 15, so that it is possible to cope with a mistake in operating the virtual button 60 on the take-out confirmation screen shown in FIG. 9. That is, if the user intends to operate the luggage redeposit button 78 but operates the take-out button 79 by mistake on the take-out confirmation screen shown in FIG. 9, the use of the box 11 or 11a can be prevented from being terminated against the user's intention.

### Second Embodiment

Next, a second embodiment will be described. In the following description, the components that are equivalent to those of the first embodiment are designated by the same reference characters, the description thereof is omitted, and the differences will be mainly described.

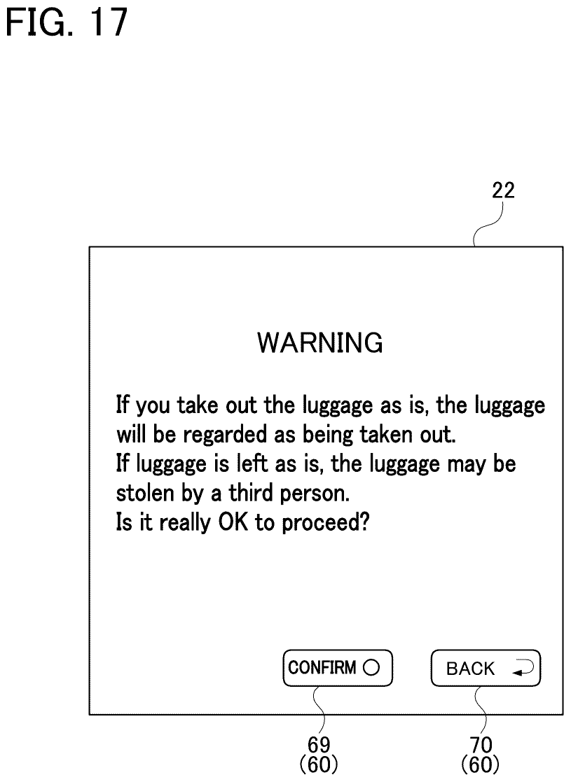

This embodiment is different from the first embodiment in the content of the transition screen displayed on the display unit 22 when the “luggage take-out mode” is executed. That is, in the first embodiment, the “first warning screen” shown in FIG. 13 and the “second warning screen” shown in FIG. 14 are provided between the end screen shown in FIG. 12 and the box unlocking screen shown in FIG. 15. In contrast, in this embodiment, the “first warning screen” shown in FIG. 13 and the “second warning screen” shown in FIG. 14 are deleted from the series of transition screens shown in FIG. 3 to FIG. 16, and instead, a “warning screen” shown in FIG. 17 is provided between the “box selection screen” shown in FIG. 8 and the “take-out confirmation screen” shown in FIG. 9.

On the warning screen shown in FIG. 17, a text or the like and virtual buttons 60 that can be tapped are displayed. An explanation text “Warning: If you take out the luggage as is, the luggage will be regarded as being taken out. If luggage is left as is, the luggage may be stolen by a third person. Is it really OK to proceed?” is displayed in the middle part of the warning screen. In addition, a confirmation button 69 and a back button 70 are displayed in the lower part of the warning screen.

With the configuration of this embodiment, unlike the first embodiment, as for the transition screens when the “luggage take-out mode” is executed, the “first warning screen” shown in FIG. 13 and the “second warning screen” shown in FIG. 14 are deleted from the series of transition screens, and instead, the “warning screen” shown in FIG. 17 is provided between the “box selection screen” shown in FIG. 8 and the “take-out confirmation screen” shown in FIG. 9, so that a mistake in operation between the luggage redeposit button 78 and the take-out button 79 on the take-out confirmation screen shown in FIG. 9 can be prevented.

### OTHER EMBODIMENTS

The disclosed technique is not limited to the above embodiments, and can also be implemented by changing part of the components as appropriate without departing from the scope of the gist of the disclosed technique.

(1) In the above embodiments, for the locker apparatus 1, it is assumed that the user who deposits luggage and the user who takes out luggage are the same person. In contrast, it is also possible to assume that the user who deposits luggage and the user who takes out luggage are different persons. More specifically, in recent years, the idea of using railroad stations as logistics bases has become more widespread, so that it is conceivable that the user who deposits luggage is a transport business operator who delivers commodities ordered by a general consumer, and the user who takes out luggage is the general consumer who had ordered the commodities. In this case, for example, a specific transport business operator is allowed to use the locker apparatus 1, and after the transport business operator is authenticated using the operation unit 20, the deposit program 32a is activated. For authentication in taking out luggage, for example, a private code for authentication such as a QR code (registered trademark) for authentication may be transmitted to a mobile terminal or the like of the general consumer, and after the private code is authenticated, the take-out program 32b may be activated.

(2) In the above embodiments, the box 81 in the illustration of the locker apparatus displayed on the box unlocking screen shown in FIG. 15 is an example of the “luggage lamp”. In contrast, for example, a dedicated lamp as the “luggage lamp” may also be provided in the operation unit 20 shown in FIG. 1.

(3) In the above embodiments, as an example, the disclosed technique is embodied in the locker apparatus 1 installed on the premises of a station, but is not limited thereto, and, for example, a home delivery box installed in a housing complex or the like may be adopted.

The disclosed technique can be used, for example, for a locker apparatus installed on the premises of a station.

### REFERENCE SIGNS LIST

1 Locker apparatus
11 Box
11a Small box
12 Door
13 Locking device
20 Operation unit
30 Control device
40 Luggage sensor
50 Communication unit (reservation acceptance member)
62 Take-out button
81 Box in an illustration of a locker apparatus (luggage lamp)

What is claimed is:

1. A locker apparatus comprising:
a box capable of accommodating luggage therein;
a door configured to open and close the box;
a locking device configured to unlockably lock the door;
an operation unit configured to receive an operation by a user; and
a control device configured to control the locking device in response to an operation on the operation unit by the user, wherein
the control device is configured to lock the locking device in order to lock the door into a closed state except when the luggage is deposited in the box and when the luggage is taken out from the box,
the box is provided with a luggage sensor for detecting luggage in the box,
the operation unit includes a take-out button that is operated by the user in order to take out the luggage from the box in which the user has deposited the luggage, and
when the take-out button is operated by the user, the control device unlocks the locking device in order to open the door of the box in which the luggage has been deposited, and when the door is closed thereafter and it is determined that there is the luggage in the box based on a detection result of the luggage sensor, the control device maintains unlocking of the locking device.

2. The locker apparatus according to claim 1, further comprising a luggage lamp configured to operate in order to indicate whether or not there is the luggage in the box, wherein
the control device causes the luggage lamp to light up or flash while determining that there is the luggage in the box as a target based on the detection result of the luggage sensor after the take-out button is operated by the user.

3. The locker apparatus according to claim 1, further comprising reservation acceptance member configured to accept a use reservation for the box, wherein
the control device is configured to record and manage a current status of each box that is in use and each box that is not in use, and to manage acceptance and recording of a use reservation from the reservation acceptance member for each box that is not in use, and
the control device stops accepting a use reservation from the reservation acceptance member for the box in which it is determined that there is the luggage based on the detection result of the luggage sensor.

4. The locker apparatus according to claim 2, further comprising reservation acceptance member configured to accept a use reservation for the box, wherein
the control device is configured to record and manage a current status of each box that is in use and each box that is not in use, and to manage acceptance and recording of a use reservation from the reservation acceptance member for each box that is not in use, and
the control device stops accepting a use reservation from the reservation acceptance member for the box in which it is determined that there is the luggage based on the detection result of the luggage sensor.
